(19) United States
(12) Patent Application Publication
(10) Pub. No.: US 2024/0192404 A1
(43) Pub. Date: Jun. 13, 2024

(54) IDENTIFYING INFLUENTIAL DISTURBANCES FROM FAILURE OR MALFUNCTION EVENTS

(71) Applicant: International Business Machines Corporation, Armonk, NY (US)

(72) Inventors: Emmanuel Yashchin, Yorktown Heights, NY (US); Nianjun Zhou, Chappaqua, NY (US); Anuradha Bhamidipaty, Yorktown Heights, NY (US); Dhavalkumar C. Patel, White Plains, NY (US); Arun Kwangil Iyengar, Yorktown Heights, NY (US); Shrey Shrivastava, White Plains, NY (US)

(21) Appl. No.: 18/063,637

(22) Filed: Dec. 8, 2022

(51) Int. Cl. G01W 1/10; G06N 7/01

(52) U.S. Cl. CPC G01W 1/10; G06N 7/01

(57) ABSTRACT

An embodiment for identifying influential disturbances is provided. The embodiment may automatically receive a set of service records including disturbance-related probability values corresponding to the disturbance-revealing events, and wherein one or more service records are mislabeled or have no label relating to an associated disturbance. The embodiment may generate baselines for a series of relevant sub-regions associated with the service records, and normalize daily summaries of disturbance probabilities for each of the relevant sub-regions. The embodiment may automatically identify subsets of service records corresponding to a series of newly-discovered disturbances by using the disturbance-related probability values and a series of associated features to identify deviations from normal non-disturbance event distributions. The embodiment may automatically identify and output a series of influential disturbances, the series of influential disturbances including newly-discovered disturbances for which a series of generated impact scores are above a predetermined threshold.

### BACKGROUND

The present application relates generally to predicting and forecasting environmental disturbance caused outages, and more particularly, to identifying influential disturbances over multiple geographic regions.

Environmental disturbances, such as weather storms, blizzards, and electromagnetic disasters, often cause failure or malfunction of assets and related outage events leading to service quality issues and negative impacts to various infrastructure service capabilities. The scale of the environmental disturbances is dependent upon a variety of factors, such as, for example, the location-specific weather or electromagnetic conditions (wind speed, wind gusts, total precipitation), the robustness of affected infrastructure or devices, and more. The ability of a given business to effectively manage environmental disturbances is dependent upon its ability to timely and accurately discover and categorize influential disturbances.

### SUMMARY

According to one embodiment, a method, computer system, and computer program product for identifying influential disturbances is provided. The embodiment may include automatically receiving, by a computer, a set of service records from a data source, each service record corresponding to disturbance-revealing events within a specified region occurring during a time period, each service record further including disturbance-related probability values corresponding to the disturbance-revealing events, and wherein one or more service records are mislabeled or have no label relating to an associated disturbance. The embodiment may also include automatically removing from the set of service records any service records having a disturbance-related probability value above a threshold that are associated with a known global storm. The embodiment may further include automatically generating baselines for a series of relevant subregions associated with a remaining set of service records, and normalizing daily summaries of disturbance probabilities for each of the relevant sub-regions. The embodiment may also include automatically identifying subsets of service records corresponding to a series of newly-discovered disturbances by using the disturbance-related probability values and a series of associated features for each of the subset of service records to identify deviations from normal non-disturbance event distributions. The embodiment may further include automatically filtering out service records in the identified subset of service records corresponding to known disturbances. The embodiment may also include automatically aggregating and splitting the known disturbances and the newly-discovered disturbances to obtain a final set of disturbances, and applying a common metric to determine a score for each of the newly-discovered disturbance. The embodiment may further include automatically identifying and outputting a series of influential disturbances, the series of influential disturbances including newly-discovered disturbances for which the determined scores are above a predetermined threshold

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for a process of identifying influential disturbances according to at least one embodiment;

FIG. 3 illustrates an exemplary generalized remediation process for updating received service records according to at least one embodiment;

FIG. 4A depicts a table summarizing notation and exemplary default values used in the change-point analyses according to at least one embodiment;

FIG. 4B depicts a table showing a summary of the multiple time series data used in the analyses according to at least one embodiment;

FIG. 5 depicts a disturbance lifetime such as a storm having a life cycle involving three states; and

FIG. 6 depicts an exemplary CUSUM control plot of computed CUSUM values plotted against time for illustrating aspects of applying the calibrated change point algorithm used for identifying boundaries of a local disturbance;

FIG. 7 depicts an exemplary dataset associated with newly-discovered disturbances that may be processed to generate scores relating to disturbance scale according to at least one embodiment; and

FIG. 8 depicts an exemplary framework and components for carrying out an exemplary validation and remediation process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

By way of example, the system framework is described in an example context of weather related disturbance management, e.g., implemented by a utility company. Of special interest are disturbances related to storms, and companies of this type tend to emphasize preparedness, minimizing the number of customers affected, and resource planning. It is thus vital for them to understand the relationship between the disturbances (weather conditions) and their outages.

To aid in the explanation, several definitions of terms are provided in the context of managing weather-related outages.

A “service” refers the act of performing work for customers in accordance with some contractual obligations. Examples include providing electrical power or computing support. In an example, a focus is on the interests of service-providing companies, such as power utilities.

A “disturbance” is an interruption of a settled or normal condition of services. Disturbances can be fully or partially predictable. Their effect is to alter or stress the infrastructure supporting the services to the extent that causes service quality issues, such as interruptions. In the weather-related outage analysis, a disturbance corresponds to storms. In this context, the impact of a disturbance is often related to the power line infrastructure of the local sub-region and its properties (e.g., demography or topography). Another example of a disturbance in another domain or context is a disturbance such as a change in a computer operating system, e.g., in the case of a help desk service domain.

A “local disturbance” is a disturbance identified for a specific geographic region.

An “event” is a maintenance or repair request to provide corrective action to ensure a service's quality. Events may (or may not) be related to disturbances. In the storm analysis, events often correspond to power restoration requests in the form of outage repair tickets.

A “Disturbance-Revealing Event (DRE)” is a specific family of events that tend to occur more often in the presence of disturbance than in its absence. Such events could be identified through prior subject matter knowledge or via statistical analysis. In the case of storm outage analysis, one type of DRE corresponds to a power failure caused by a fallen tree; another type would be a power outage caused by the necessity to remove a tree leaning towards an utility power line. In the context of weather-related outages, DREs are associated with service records or tickets that are sometimes referred to herein as storm-revealing tickets (SRTs).

“Prior-known Disturbances” are a set of disturbances known before the event assignment to them. In weather-related applications, these are the “known storms”, aka. “named storms”.

“Prior-labeled Events” are events have been assigned to respective disturbances. In a weather-related example, they represent the service records or tickets that are assigned to a storm by the time they are closed.

A “Disturbance-Related probability” is the probability of a DRE event to be associated with a disturbance. In the case of weather outages, this is a probability that a given SRT is associated with a storm.

“Labeling” is a process of assigning a DRE (or SRT) to a disturbance. Such assignments could be deterministic (i.e., TRUE/FALSE) or probabilistic. In weather-related applications, assigned probabilistic labels attribute the SRTs to likely being associated with either known or newly discovered storms.

A “Validation” is the process of establishing consistency of probabilistic labels based on the set of the prior-labeled events and the time periods corresponding to known and newly discovered storms. Event and disturbances are often location-specific. For example, in a given storm outage analysis, the service records or tickets may be sub-divided into sub-regions due to the process of ticket initiation and the storm's spatial coverage. As validation results improve, the ability of a given system to have higher recall in identifying known labels improves.

Embodiments of the present application relate generally to predicting and forecasting environmental disturbance caused outages, and more particularly, to identifying influential disturbances over multiple geographic regions. The following described exemplary embodiments provide a system, method, and program product to, among other things, automatically receive, by a computer, a set of service records from a data source, each service record corresponding to disturbance-revealing events within a specified region occurring during a time period, each service record further including disturbance-related probability values corresponding to the disturbance-revealing events, and wherein one or more service records are mislabeled or have no label relating to an associated disturbance. The described exemplary embodiments may then automatically remove from the set of service records any service records having a disturbance-related probability value above a threshold that are associated with a known global storm, automatically generate baselines for a series of relevant subregions associated with a remaining set of service records, and normalize daily summaries of disturbance probabilities for each of the relevant sub-regions, and then automatically identify subsets of service records corresponding to a series of newly-discovered disturbances by using the disturbance-related probability values and a series of associated features for each of the subset of service records to identify deviations from normal non-disturbance event distributions. Thereafter, the described exemplary embodiment may automatically filter out service records in the identified subset of service records corresponding to known disturbances, automatically aggregate and split the known disturbances and the newly-discovered disturbances to obtain a final set of disturbances, apply a common metric to determine a score for each of the newly-discovered disturbances, and automatically identify and output a series of influential disturbances, the series of influential disturbances including newly-discovered disturbances for which the determined scores are above a predetermined threshold. Therefore, the presently described embodiments have the capacity to improve processes of identifying influential disturbances by using disturbance related-probability values and other features to identify spatial-temporal clusters of records corresponding to deviations from normal non-disturbance event distributions in order to identify influential disturbances that may have been previously unidentified and not contained in labels within a set of received service records.

As previously described, environmental disturbances, such as weather storms, blizzards, and electromagnetic disasters, often cause failure or malfunction of assets and related outage events leading to service quality issues and negative impacts to various infrastructure service capabilities. The scale of the environmental disturbances is dependent upon a variety of factors, such as, for example, the location-specific weather or electromagnetic conditions (wind speed, wind gusts, total precipitation), the robustness of affected infrastructure or devices, and more. The ability of a given business to effectively manage environmental disturbances is dependent upon its ability to timely and accurately discover and categorize influential disturbances.

Systems for detecting environmental disturbances, particularly weather-related disturbances, are constantly improving. For example, some systems can now output disturbance-related probability values indicating the probability of a disturbance revealing event being associated with a given disturbance. However, there are still several challenges for businesses trying to employ systems to detect and monitor environmental disturbances. For example, in many systems, when weather-related disturbances are detected, only major environmental disturbances are utilized to annotate events. Thus, there are many missed global disturbances (for example, smaller scale storms) that are not considered. This may lead to physical causes of a given disturbance not aligning with the impact of the disturbance. Other challenges arise in systems where relationships between disturbances and events (tickets) are established manually. In these systems there is only limited cause-effect annotation, and the data collection is prone to human error. The above-described challenges may lead to missed global disturbances that may be influential in nature, affecting multiple sub-regions. These missed global disturbances represent missing information and data that could be leveraged by businesses to improve their ability to more effectively monitor and manage environmental disturbances.

Accordingly, a method, computer system, and computer program product for improved methods of identifying influential disturbances would benefit many businesses attempting to timely and accurately discover and categorize influential disturbances to effectively manage resulting malfunctions or outages. The method, system, and computer program product may automatically receive, by a computer, a set of service records from a data source, each service record corresponding to disturbance-revealing events within a specified region occurring during a time period, each service record further including disturbance-related probability values corresponding to the disturbance-revealing events, and wherein one or more service records are mislabeled or have no label relating to an associated disturbance. The method, system, computer program product may automatically remove from the set of service records any service records having a disturbance-related probability value above a threshold that are associated with a known global storm. The method, system, computer program product may then automatically generate baselines for a series of relevant subregions associated with a remaining set of service records, and normalize daily summaries of disturbance probabilities for each of the relevant sub-regions. The method, system, computer program product may then automatically identify subsets of service records corresponding to a series of newly-discovered disturbances by using the disturbance-related probability values and a series of associated features for each of the subset of service records to identify deviations from normal non-disturbance event distributions. Then, the method, system, computer program product may automatically filter out service records in the identified subset of service records corresponding to known disturbances. Next, the method, system, computer program product may automatically aggregate and split the known disturbances and the newly-discovered disturbances to obtain a final set of disturbances, and apply a common metric to determine a score for each of the newly-discovered disturbances. Thereafter, the method, system, computer program product may automatically identify and output a series of influential disturbances, the series of influential disturbances including newly-discovered disturbances for which the determined scores are above a predetermined threshold. Described embodiments provide a method of identifying influential disturbances by using disturbance related-probability values and other features to identify spatial-temporal clusters of records corresponding to deviations from normal non-disturbance event distributions in order to identify influential disturbances that may have been previously unidentified and not contained in labels within a set of received service records. Described embodiments employ functions leveraging disturbance-related probability values and other ticket features to utilize the type and magnitude of events to determine influential disturbances that affect multiple sub-regions. Described embodiments will further employ change-point algorithms to establish distance boundaries, and will aggregate contributions from multiple sub-regions in the process of identifying influential disturbances.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

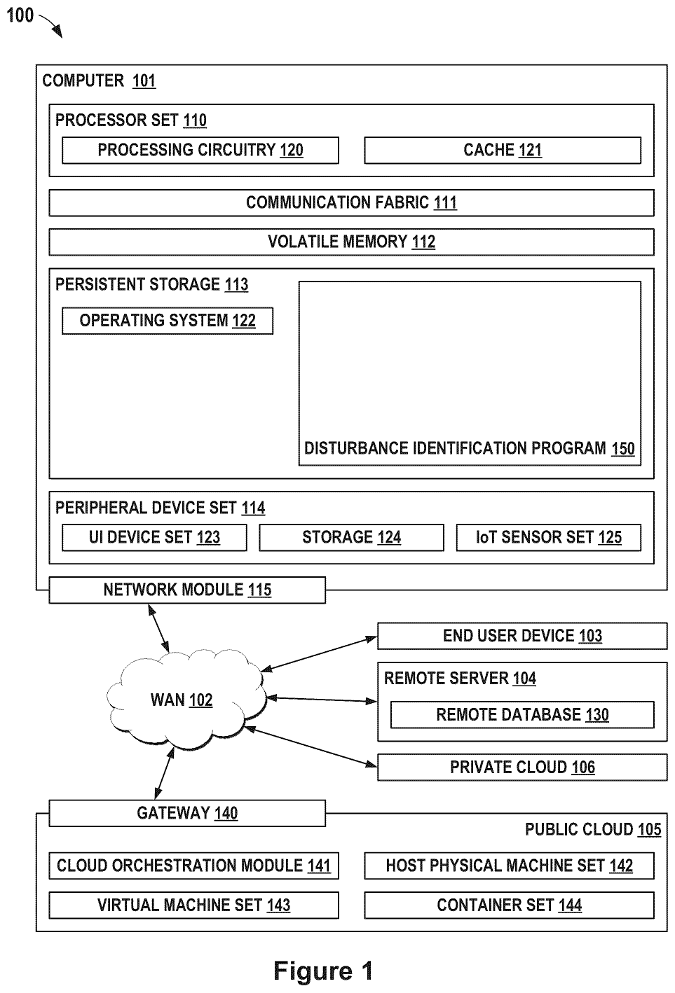

Referring now to FIG. 1, computing environment 100 contains an example of an environment for the execution of at least some of the computer code involved in performing the inventive methods, such as disturbance identification program/code 150. In addition to disturbance identification code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and disturbance identification code 150, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in disturbance identification code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in disturbance identification code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the disturbance identification program 150 may be a program capable of automatically receiving, by a computer, a set of service records from a data source, each service record corresponding to disturbance-revealing events within a specified region occurring during a time period, each service record further including disturbance-related probability values corresponding to the disturbance-revealing events, and wherein one or more service records are mislabeled or have no label relating to an associated disturbance. Disturbance identification program 150 may then automatically remove from the set of service records any service records having a disturbance-related probability value above a threshold that are associated with a known global storm. Next, disturbance identification program 150 may automatically generate baselines for a series of relevant subregions associated with a remaining set of service records, and normalize daily summaries of disturbance probabilities for each of the relevant sub-regions. Disturbance identification program 150 may then automatically identify subsets of service records corresponding to a series of newly-discovered disturbances by using the disturbance-related probability values and a series of associated features for each of the subset of service records to identify deviations from normal non-disturbance event distributions. Next, disturbance identification program 150 may automatically filter out service records in the identified subset of service records corresponding to known disturbances. Then, disturbance identification program 150 may automatically aggregate and split the known disturbances and the newly-discovered disturbances to obtain a final set of disturbances, and apply a common metric to determine a score for each of the newly-discovered disturbances. Thereafter, disturbance identification program 150 may automatically identify and output a series of influential disturbances, the series of influential disturbances comprising newly-discovered disturbances for which the determined scores are above a predetermined threshold. In turn, disturbance identification program 150 has provided improve processes of identifying influential disturbances by using disturbance related-probability values and other features to identify spatial-temporal clusters of records corresponding to deviations from normal non-disturbance event distributions in order to identify influential disturbances that may have been previously unidentified and not contained in labels within a set of received service records.

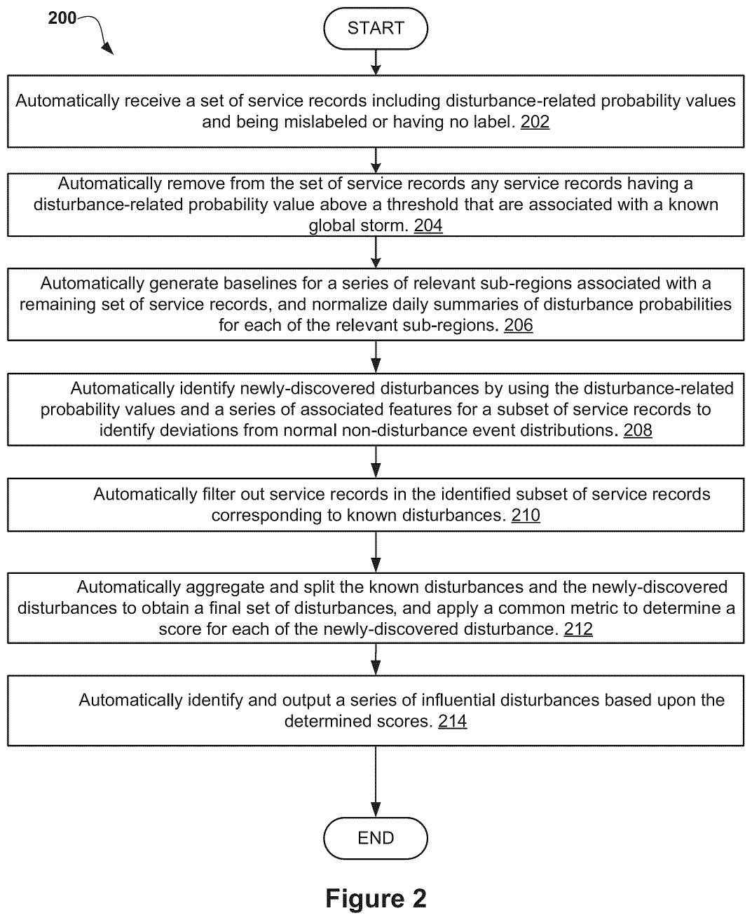

Referring now to FIG. 2, an operational flowchart for a process 200 of identifying influential disturbances according to at least one embodiment is provided.

At 202, disturbance identification program 150 may automatically receive, by a computer, a set of service records from a data source, each service record corresponding to disturbance-revealing events (DRE) within a specified region occurring during a time period, each service record further including disturbance-related probability values corresponding to the disturbance-revealing events and being mislabeled or having no label relating to an associated disturbance. For example, disturbance identification program 150 may receive an exemplary dataset of electric utility service records for events (tickets) corresponding to the handling of real and anticipated outages. In embodiments, each event may be self-contained and indicate multiple attributes. There is no limit to the number of records in a set of service records and the set of service records may contain hundreds of thousands of records covering multiple substations and spanning a period of years. Examples of fields of data included in an exemplary set of service records (for each ticket/event) may include, but is not limited to, an event or ticket ID field, an estimated start time of an outage, a timestamp for the time of ticket initiation, an effective substation field indicating an affected coverage area, a Storm ID field, a cause description field indicating a cause of a specific outage, a field indicating the number of customers affected, etc. There may be an additional field corresponding to an end time including a timestamp that is filled at the ticket closing. While some tickets may have an assigned storm ID—however, before remediation, there are many storm-related ticket records for which this associated Storm ID field is missing or empty. Furthermore, there exist tickets for which this field is erroneous. Thus, as will be discussed in more detail below, imputation and remediation actions are necessary in relation to these fields/records.

As stated above, the set of service records received by disturbance identification program 150 each include a disturbance-related probability value corresponding to the disturbance-revealing events for each service record. This value reflects the probability (p) of a DRE event within a given region to be associated with a disturbance. This probability value ‘p’ will be leveraged by disturbance identification program 150 to discover previously missing or hidden influential disturbances.

Next, at 204, disturbance identification program 150 may automatically remove from the set of service records any service records having a disturbance-related probability value above a threshold that are associated with a known global storm (i.e. storms that are not unknown or ‘hidden’). This threshold value is predetermined and may be modified to reflect a subjective numerical value consider by a user to be reflective of an event being associated with a known global storm. At this step, disturbance identification program 150 may also determine whether a given known global storm is influential by considering a set of special metrics for this purpose, the special metrics may include, for example, disturbance duration, number of customers affected, and cost to achieve restoration. For example, disturbance identification program 150 may be configured to include a threshold value of 0.8. Thus, if an exemplary ‘Service Record A’ has a disturbance-related probability value of 0.9 and is associated with a known global storm, disturbance identification program 150 would automatically filter out (remove) exemplary ‘Service Record A’ from further consideration as it moves forward in the process of identifying missing or hidden influential disturbances. Disturbance identification program 150 may also, based on the disturbance duration, number of customers affected, costs to achieve restoration, and other associated disturbance data in exemplary ‘Service Record A’, determine whether exemplary ‘Service Record A’ is associated with an influential storm.

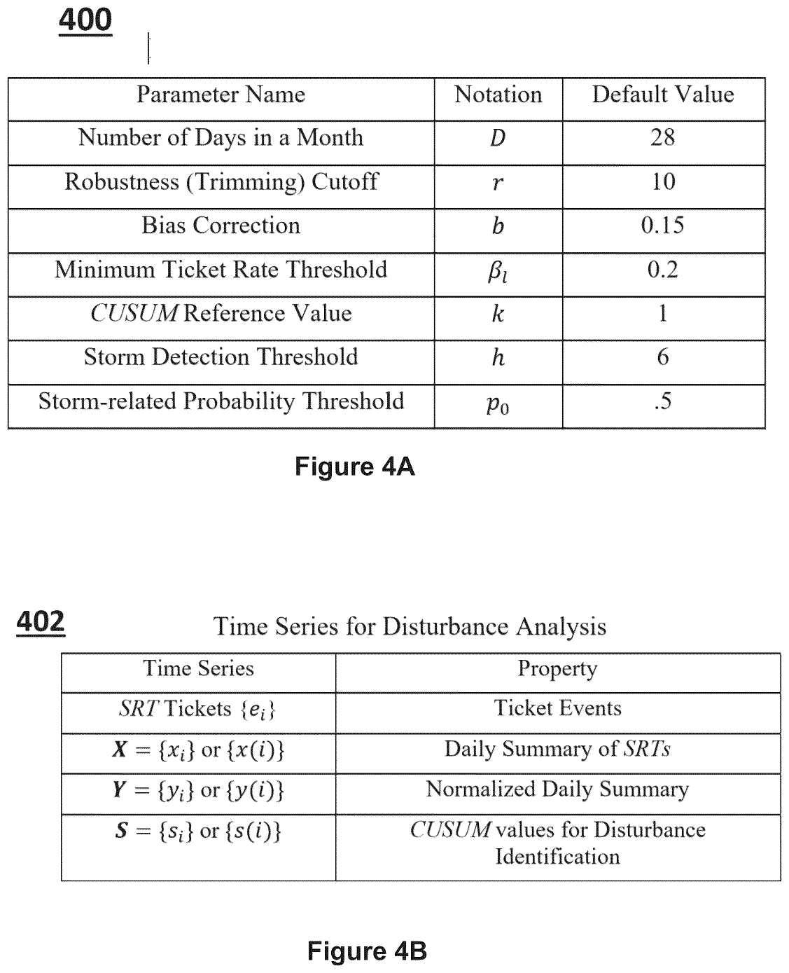

At 206, disturbance identification program 150 may automatically generate baselines for a series of relevant subregions associated with a remaining set of service records and normalize daily summaries of disturbance probabilities for each of the relevant sub-regions. When disturbance identification program 150 generates a baseline, it is assumed that the non-storm periods provide enough information to estimate the daily baseline rate of storm-related tickets (SRTs), i.e., the rate that would have been observed in the absence of storms. The baseline rate may be location-specific and may consider various seasonality factors. For example, “normal” seasonal effects, e.g., including the effect of el-nino years, and even fiscal end-of-year or quarterly considerations that could affect planned ticket handling may be considered and adjusted for using known statistical methods. Disturbance identification program 150 may then utilize a calibrated change-point algorithm to identify local storms, i.e., identify the disturbance scale, lifetime, and dynamic status (start, middle and end or SME). At such time, disturbance identification program 150 may record new storm IDs for newly identified events (e.g., storms) for a specific location or subarea. The Table 400 shown in FIG. 4A summarizes the notation and exemplary default values used in the change-point analyses. The multiple time series used in these analyses are summarized in Table 402 of FIG. 4B.

For a given month, the daily values of the function ψ(p, u) are observed, where p is the vector of disturbance-related (storm-related) probabilities corresponding to the DREs observed over the day (or selected time interval), and u reflects other ticket (event) properties. For a given time period, e.g., a month, disturbance identification program 150 may combine the values of y into a random variable vector {xᵢ}:

{xᵢ}={ψ(pᵢ,uᵢ)}

The index i is the date, e.g., within a month. In an embodiment, the estimation applies to months with complete monthly data (so, the available date indices are i=1, 2, . . . , D where D>=28). Further, disturbance identification program 150 denotes the daily mean value (under non-storm conditions) for the month under consideration by λ. One objective is to find a robust estimate (\hat{λ}) based on the observed values for Xᵢ under non-disturbance conditions. This value is then treated as a baseline for every day in this month, in the considered sub-region.

The method steps for computing (\hat{λ}) is as follows:
1) Set a trimming number r (e.g., choose the default, r=10), and remove the daily mean values of highest r and lowest r values of Xᵢ from the monthly data. It is understood that the trimming number, r=10, establishes the breakdown value of the estimator: it can handle up to 10 stormy days in any given month without producing an outlier-induced bias. Generally, the trimmed mean gives an unbiased estimate of the central tendency for symmetric distributions. The distribution of Xᵢ is likely to be right-skewed, so the conventional trimmed estimator is systemically biased downward as the points removed from the top are more influential than the points removed from the bottom. This bias is bounded, and it tends to a limit b as λ→∞;
2) Calculate the trimmed mean X̅_{{r}}=X̅_{{10}} by averaging the remaining data points in X;
3) Apply an additive adjustment factor (Bias Correction) b, e.g., b=0.15, to obtain an intermediate estimate according to:

\hat{λ}=X̅_{{10}}+b;
4) Correct the robust estimate by preventing it from being too small. To this end, a lower threshold βₗ is applied, e.g., βₗ=0.2, where, under non-storm conditions, it is expected, on average, at least one SRT per 5 days for every service sub-region. The new estimate of \hat{λ} is computed as:

\hat{λ}=max(\hat{λ},Bₗ).

With the baseline available for every month of every year and for every sub-region, there is further performed the isolation of the storm periods. To achieve this goal, all the daily values Xᵢ are standardized so that under the non-storm conditions, they form a sequence of variables that are marginally distributed with mean 0 and standard deviation 1. For a given month, the standardized values represent a set of scores (a time series) Y={yᵢ} that is related to the original daily mean values X={xᵢ} and \hat{λ} via the formula according to equation 1 as follows:

$${y}_{i} = \{ \frac{{x}_{i} - \hat{λ}}{\hat{σ}} \} \sim N ( 0 , 1 )$$

where i=1, 2, . . . , D, and \hat{σ} is a scaling constant to achieve a calibration to a standard Gaussian distribution. The scaling constant sigma-hat can be estimated for the rate of SRTs, \hat{σ}=\sqrt{\hat{λ}}, however the scaling constant \hat{σ} can be estimated in a variety of ways. When the monthly series of scores are combined into a single time series, the storm periods will correspond to a segment of elevated values of yᵢ (values of xᵢ increase) and these segments can be detected and bounded. As noted above, xᵢ is influenced by the input of disturbance-related probability values corresponding to variable p. Standardization of daily Xᵢ values enables use of a unified type of algorithm applicable to all the series of scores in the data set.

In an alternate embodiment, rather than computing the daily mean value under non-storm conditions for each month and assigning the value to each day of the month, a sliding window can be used within which the same operations can be performed and the baseline computed as a moving average. That is, the procedure is applied to a sliding window (for example, of length=D days) can be used within which the same operations can be performed. The baseline value computed based on this window is assigned to the day i=mid-point of window. Thus, new values are delivered to the baseline curve as the window slides.

At 208, disturbance identification program 150 may automatically identify subsets of service records corresponding to a series of newly-discovered disturbances by using the disturbance-related probability values and a series of associated features for each of the subset of service records to identify deviations from normal non-disturbance event distributions. With the baseline values for each month generated at 206 and converted thereafter to the standardized time series (1) of scores, disturbance identification program 150 is positioned to discover new or hidden disturbances. Disturbance identification program 150 identifies signals of disturbances in each sub-region, and then identifies global disturbances from these signals. To accomplish this, disturbance identification program 150 first creates a CUSUM time series of daily Y (determined at 206 using disturbance-related probability values), observed for a given location in a set, and uses I(t) as an indicator for a disturbance. Disturbance identification program 150 may generate two time series for each substation: S(t), I(t), where S is the CUSUM and I is the indicator for a disturbance (T is the time range of the studied time series X).

Disturbance identification program 150 may apply a form of the cumulative sum (CUSUM) time series of daily Y, observed for locations in a given record set, and an initial value s₀ as a parameter of the algorithm. Disturbance identification program 150 may utilize exemplary processes according to the following exemplary algorithm:
s_previous=s₀ (a fraction of h, such as 0.5h)
for t in T: y=Y(t)
   s=max(s_previous+Y(t)−k),0)
   if (s>h):
      s_previous=s₀
      S(t)=s
      D(t)=1
   else:
      s_previous=s₀

In an embodiment, the threshold h is chosen to achieve the desired trade-off between the rate of false alarms and sensitivity. In an embodiment, the value h can equal 5. However, as the scores Y in the above equation exhibit some positive skew, and serial correlation, a higher threshold is necessitated to achieve reasonable protection of false alarms. Thus, a somewhat higher threshold, h=6, is used in an embodiment. The reference value k functions to pull the CUSUM downward as the method continues to accumulate the difference between a value of Y and k value (where Y is essentially noise of a value around 0 during non-storm conditions.

Disturbance identification program 150 may identify signals of newly-discovered disturbances for instances where s is above h. In addition to identifying signals of disturbances, disturbance identification program 150 may then compute a value Iₗ which represents a local indicator time series for inside (1) or outside (0) of the local disturbances detected. Disturbance identification program 150 may then apply a threshold function to the summation Iₗ. For example, disturbance identification program 150 may use the following exemplary threshold function:

I(t)=Σₗ₌₁^{N}Iₗ(t)

Thus, disturbance identification program 150 could take localized intensity measurements for three exemplary sub-regions given by I₁, I₂, and I₃ and use the above threshold function to sum and standardize the individual intensity measurements to obtain a rough estimate of a disturbance intensity value for a corresponding region.

Once disturbance identification program 150 has knowledge of the CUSUM time series and indicators of newly-discovered disturbances based on deviation from normal non-disturbance event distributions (based on the baseline), disturbance identification program 150 may establish the beginning and end dates of each disturbance.

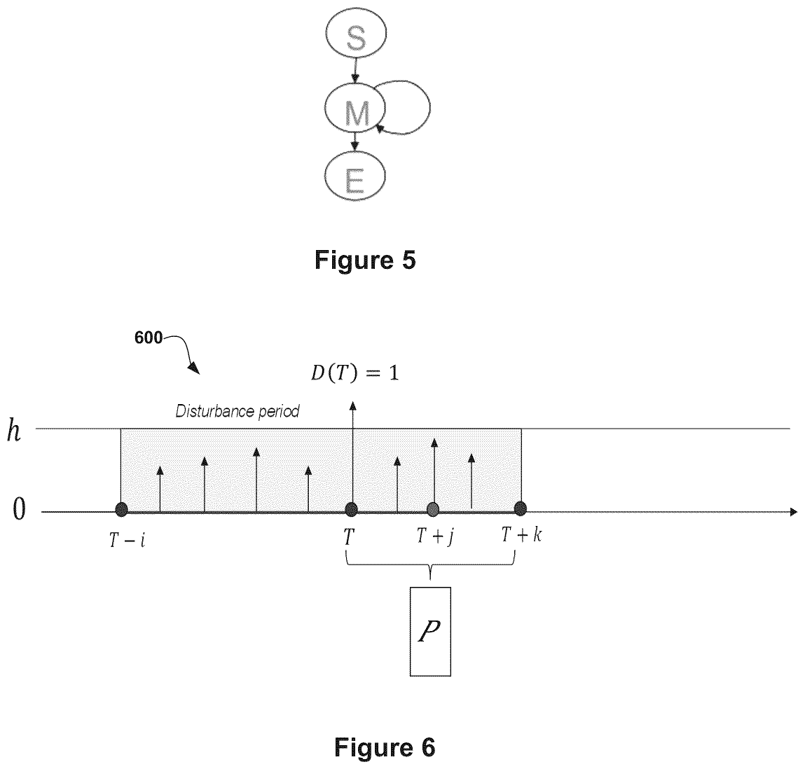

In an embodiment, a calibrated change-point algorithm may be used to establish boundaries of newly-discovered disturbances (for example, storms). As shown in FIG. 5, a storm has a life cycle involving three states: start (S), middle (M), and end (E). For any given day, there is a corresponding state, shown in FIG. 5, chosen from the set [N, S, M, E] with N representing the normal (non-storm) date.

With the knowledge of the CUSUM time series and the indicators of discovered disturbances, disturbance identification program 150 may establish the beginning and end dates of each disturbance. FIG. 6 depicts an exemplary CUSUM control plot 600 of computed CUSUM values plotted against time and illustrates aspects of applying an exemplary calibrated change point algorithm used for identifying boundaries disturbance (e.g., storm). For a known disturbance indicator corresponding to a time of detection T, the boundaries of the disturbance are defined as [T−i, T+j]. In FIG. 6. [T+k] is the first time after T that the process described above in paragraph [0067] reaches a level 0. It should be noted that after time of detection T, this process can have several points of exceedance over the threshold h, however, in FIG. 6 only one cycle is shown. The value [T+j] is determined only after a final cycle ends in the scheme described above at paragraph [0067], reaching a level 0 for the first time after T. i.e., after establishing [T+k]. Accordingly, the CUSUM value for S_{T-i}=0 is the last zero-valued scheme point before the T. The point at which s_{T+k}=0 is the first zero-valued scheme point after the T, so 0≤j≤k. The case j=0 only materializes when k=1. Note, the CUSUM values in the post-detection period P reach a maximum at T+j, and k in FIG. 6 is used to compute index and has no relation to the reference value k used for computing the CUSUM time series of daily Y values above.

In an alternative embodiment, disturbance identification program 150 may perform the described steps of baseline creation at 206 and identification of disturbances at 208 using a different approach. In this embodiment, baseline creation is achieved by building a function based on aggregating daily values of a function Z and using Φ(*), an activation function designed to strengthen the signal of a disturbance. This effectively weakens the value of Y if it is small and strengthens the value of Y if it is large. The equation for this alternative embodiment is useful for avoiding the disturbance signal being diluted by sub-regions outside the disturbance impact. With suitable weights (to account for the important of sub-region) wₘ, and Y_{i,m} being the value Y computed for a given region m on day i, and ‘M’ being the cardinality of subsets of subregions (locations) of interest, the aggregating of the daily values of Y (as described above in paragraph [0063]) may be represented by:

Zᵢ=Σₘ₌₁^{M}wₘ*Φ[Y_{i,m}]

Thereafter, disturbance identification program 150 may Standardize Z using the mean and standard deviation to generate a Z′. Using Z′, signals of disturbances may be identified using the same algorithms discussed above using either two different scheme parameters (h,k), or even the same parameters, as Z has been standardized.

It should be noted that above-described CUSUM parameters (s0, h, and k) may generally be region-specific. The same type of threshold violations shown by a given sequence of scores [Y] may lead to the declaration of a local disturbance in an exemplary region A, while at the same time may not cause a similar declaration of a local disturbance in an exemplary region B. In embodiments, if exemplary region B is very sparsely populated, a user could set its threshold h to a higher level, or could increase k. It should be noted that even if several regions result in detected threshold violations, this may still not be considered a global disturbance unless certain additional conditions are met. For example, paragraph sets one such exemplary condition, that is based on the total sum of indicator functions. This sum represents its own threshold—and only when this threshold is exceeded is a global disturbance identified. Another exemplary criterion for declaring a storm “global” may be based on Zᵢ in [0074].

At 210 disturbance identification program 150 may automatically filter out service records in the identified subsets of service records corresponding to known disturbances. For example, disturbance identification program 150 may identify a subset of service records that were originally missing labels related to a disturbance when received, but upon being processed by disturbance identification program 150 are clearly related to a known disturbance based upon associated disturbance-related probability values, sub-region, incident type, and other features of the individual events or records. Accordingly, disturbance identification program 150 will filter these records out to remove them from consideration for being considered as relating to a newly-discovered influential event.

At 212, disturbance identification program 150 may automatically aggregate and split the known disturbances and the newly-discovered disturbances to obtain a final set of disturbances, and apply a common metric to determine a score for each of the newly-discovered disturbance. Aggregating refers to the process of concluding that several disturbances are part of the same disturbance, and splitting refers to the process of concluding that a disturbance should be considered as a sequence of two or more back-to-back disturbances. In the context of this disclosure, a common metric may be any standardized measurement based upon one feature or a grouping of features shared by both known and newly discovered disturbances. For example, in an exemplary embodiment disturbance identification program 150 may apply a common metric relating to ‘impact of disturbance’, that is a weighted average of disturbance duration, number of customers affected, and cost to achieve restoration. Disturbance identification program 150 may aggregate data from both known and the newly-discovered disturbances to apply the common metric and generate scores designed to reflect the scale and breadth of a given disturbance.

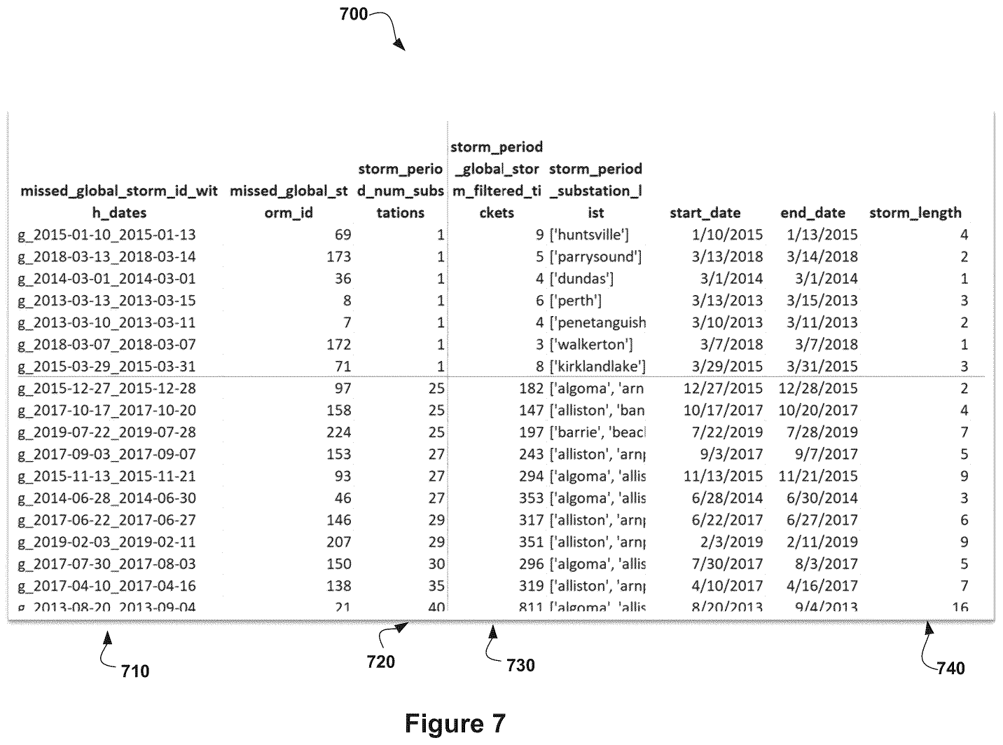

FIG. 7 depicts an exemplary dataset 700 corresponding to newly-discovered disturbances that may be used by disturbance identification program 150 to generate a score. As shown in FIG. 7, each of the disturbance ID's 710 include geographic impact data in column 720 related to the number of substations impacted by the storm, event impact data in column 730 related to the number of associated tickets, and temporal impact data in column 740 related to storm length. These datapoints may be aggregated and normalized to generate a common metric. Disturbance identification program 150 may then apply the common metric to generate scores reflecting disturbance impact based upon the aggregated data from the information contained in dataset 600. The scores generated by disturbance identification program 150 may be configured to be within any desired range. For example, generated scores may be between 0 and 1, where a disturbance having little to no impact is assigned a lower score and a disturbance that is highly impactful is assigned a score closer to 1.

At 214, disturbance identification program automatically identifies and outputs a series of influential disturbances, the series of influential disturbances including newly-discovered disturbances for which the determined scores are above a predetermined threshold. For example, disturbance identification program may be configured to generate scores at 212 between 0 and 1 as described above, and thereafter may be configured to identify and output a series of influential disturbances classified as newly-discovered disturbances having a generated score that is greater than 0.8.

It will be appreciated that disturbance identification program 150 thus provided improve processes of identifying influential disturbances by using disturbance related-probability values and other features to identify spatial-temporal clusters of records corresponding to deviations from normal non-disturbance event distributions in order to identify influential disturbances that may have been previously unidentified and not contained in labels within a set of received service records. Once disturbance identification program 150 identifies newly-discovered disturbances, it establishes a common metric to reflect the scale and impact of the disturbances and scores and filters out ‘influential disturbances’ that are sufficiently impactful. This ultimately allows users to identify missed global disturbances that may be influential in nature, affecting multiple sub-regions. These missed global disturbances represent missing information and data that users or businesses could leveraged to improve their ability to more effectively monitor and manage environmental disturbances.

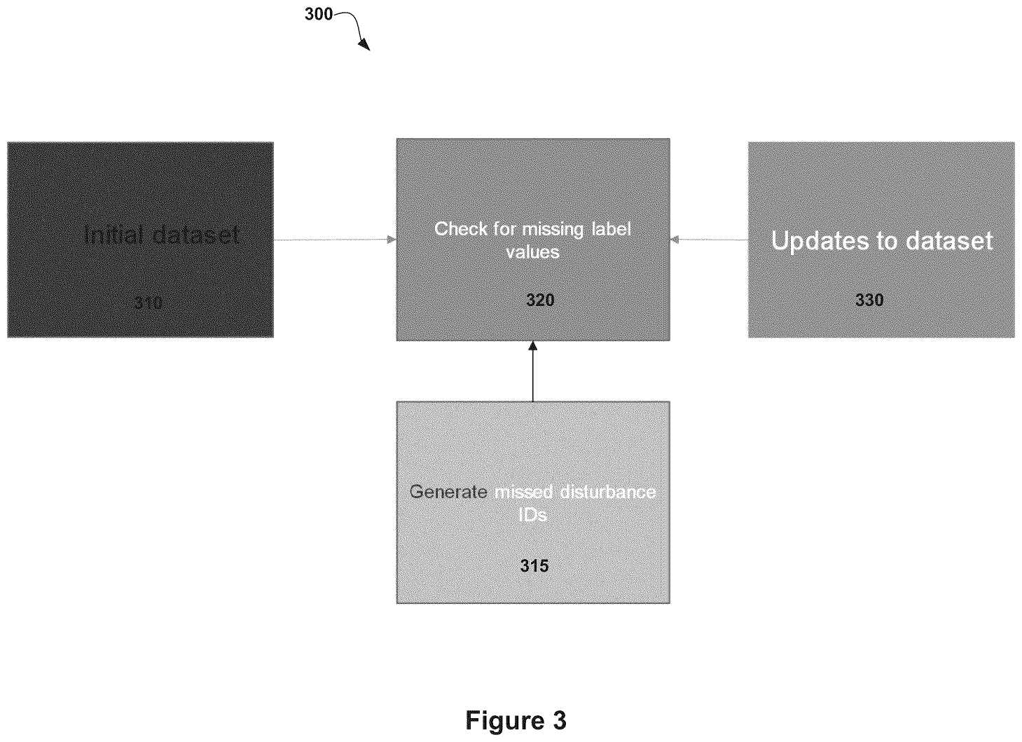

In embodiments, and as depicted in FIG. 3, disturbance identification program 150 may optionally further include a remediation process. Generally, an exemplary remediation process 300 involves the initial dataset 310 being checked for missing label values 320, and being updated at 330 using the generated missing disturbance ID's 315. More specifically, the remediation step may be performed by disturbance identification program 150 to update and bring datasets in order, identify the missed influential disturbances, and recalibrate their relevance. Such a remediation process may first include disturbance identification program 150 imputing the unidentified (newly discovered) disturbances. Next disturbance identification program 150 may establish the relevance for newly discovered disturbances from the events, i.e., the probability of an event being associated with a specific newly discovered disturbance, and then associate disturbances with the tickets. Next, disturbance identification program 150 may evaluate disturbance scale, time frame, and the impacted events (temporal and spatial). Lastly, disturbance identification program 150 may rank-order disturbances an identify influential ones having impact above a predetermined threshold as described above. Ultimately, disturbance identification program 150 is able to ensure that probabilistic labels are produced and all missing storms are identified such that the data set becomes updated and of increased suitability for training a machine learned model.

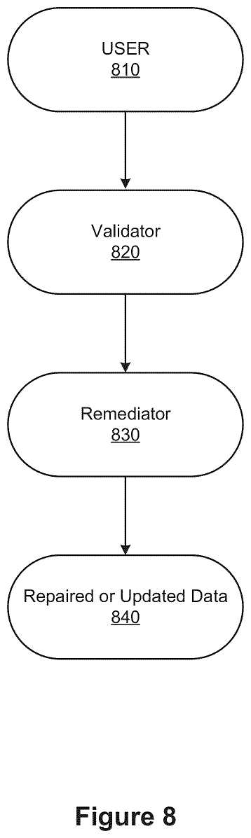

FIG. 8 depicts a framework including components for carrying out remediation process 300 or for performing one-time data repair. A user 810 may manually perform this process. Disturbance identification program 150 may then, for example, utilize a validator 820 configured to perform pre-defined or custom checks on various data frames to output a quality report that may include useful descriptions, pass/fail outputs, scores, recommendations, details, or visualizations associated with disturbance data generated by disturbance identification program 150. Disturbance identification program 150 may further utilize a remediator 820 configured to perform the above-described remediation process 300 and to further output a remediation report summarizing the results of that process. Once passing through validator 810 and remediator 820, updated records (repaired data 830) may be obtained.

It may be appreciated that FIG. 2 provides only illustrations of an exemplary implementation and does not imply any limitations with regard to how different embodiments may be implemented. Many modifications to the depicted environment may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of identifying influential disturbances comprising:
automatically receiving, by a computer, a set of service records from a data source, each service record corresponding to disturbance-revealing events within a specified region occurring during a time period, each service record further including disturbance-related probability values corresponding to the disturbance-revealing events, and wherein one or more service records are mislabeled or have no label relating to an associated disturbance;
automatically removing from the set of service records any service records having a disturbance-related probability value above a threshold that are associated with a known global storm;
automatically generating baselines for a series of relevant subregions associated with a remaining set of service records, and normalizing daily summaries of disturbance probabilities for each of the relevant sub-regions;
automatically identifying subsets of service records corresponding to a series of newly-discovered disturbances by using the disturbance-related probability values and a series of associated features for each of the subset of service records to identify deviations from normal non-disturbance event distributions;
automatically filtering out service records in the identified subset of service records corresponding to known disturbances;
automatically aggregating and splitting the known disturbances and the newly-discovered disturbances to obtain a final set of disturbances, and applying a common metric to determine a score for each of the newly-discovered disturbances; and
automatically identifying and outputting a series of influential disturbances, the series of influential disturbances comprising newly-discovered disturbances for which the determined scores are above a predetermined threshold.

2. The computer-based method of claim 1, wherein automatically identifying the subsets of the service records corresponding to the series of the newly-discovered disturbances by using the disturbance-related probability values and the series of associated features for each of the subset of service records to identify the deviations from the normal non-disturbance event distributions further comprises:
automatically utilizing a calibrated cumulative sum (CUSUM) algorithm to identify disturbance signals.

3. The computer-based method of claim 1, the method further comprising:
automatically determining start dates and end dates for each of the identified subsets of service records corresponding to the series of newly-discovered disturbances.

4. The computer-based method of claim 1, wherein the common metric comprises a standardized value reflecting scale and impact of a set including both the known disturbances and the newly-discovered disturbances based upon one or more associated disturbance features, the one or more associated disturbance features comprising one or more of: geographic impact features, temporal impact features, or event impact features.

5. The computer-based method of claim 1, the method further comprising:
automatically performing a remediation process to update the received set of service records in view of the newly-discovered disturbances.

6. The computer-based method of claim 1, wherein automatically identifying the subsets of the service records corresponding to the series of the newly-discovered disturbances by using the disturbance-related probability values and the series of associated features for each of the subset of service records to identify the deviations from the normal non-disturbance event distributions further comprises:
automatically applying a threshold function to sum a series of disturbance intensities associated with multiple sub-regions to obtain a standardized disturbance indicator value for a larger region.

7. The computer-based method of claim 1, wherein automatically identifying the subsets of the service records corresponding to the series of the newly-discovered disturbances by using the disturbance-related probability values and the series of associated features for each of the subset of service records to identify the deviations from the normal non-disturbance event distributions further comprises:
automatically applying an activation function configured to strengthen each signal of disturbance, the activation function configured to prevent disturbance signal dilution caused by a series of simultaneously detected disturbances.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
automatically receiving, by a computer, a set of service records from a data source, each service record corresponding to disturbance-revealing events within a specified region occurring during a time period, each service record further including disturbance-related probability values corresponding to the disturbance-revealing events, and wherein one or more service records are mislabeled or have no label relating to an associated disturbance;
automatically removing from the set of service records any service records having a disturbance-related probability value above a threshold that are associated with a known global storm;
automatically generating baselines for a series of relevant subregions associated with a remaining set of service records, and normalizing daily summaries of disturbance probabilities for each of the relevant sub-regions;
automatically identifying subsets of service records corresponding to a series of newly-discovered disturbances by using the disturbance-related probability values and a series of associated features for each of the subset of service records to identify deviations from normal non-disturbance event distributions;
automatically filtering out service records in the identified subset of service records corresponding to known disturbances;
automatically aggregating and splitting the known disturbances and the newly-discovered disturbances to obtain a final set of disturbances, and applying a common metric to determine a score for each of the newly-discovered disturbances; and
automatically identifying and outputting a series of influential disturbances, the series of influential disturbances comprising newly-discovered disturbances for which the determined scores are above a predetermined threshold.

9. The computer system of claim 8, wherein automatically identifying the subsets of the service records corresponding to the series of the newly-discovered disturbances by using the disturbance-related probability values and the series of associated features for each of the subset of service records to identify the deviations from the normal non-disturbance event distributions further comprises:
automatically utilizing a calibrated cumulative sum (CUSUM) algorithm to identify disturbance signals.

10. The computer system of claim 8, the method further comprising:
automatically determining start dates and end dates for each of the identified subsets of service records corresponding to the series of newly-discovered disturbances.

11. The computer system of claim 8, wherein the common metric comprises a standardized value reflecting scale and impact of a set including both the known disturbances and the newly-discovered disturbances based upon one or more associated disturbance features, the one or more associated disturbance features comprising one or more of: geographic impact features, temporal impact features, or event impact features.

12. The computer system of claim 8, the method further comprising:
automatically performing a remediation process to update the received set of service records in view of the newly-discovered disturbances.

13. The computer system of claim 8, wherein automatically identifying the subsets of the service records corresponding to the series of the newly-discovered disturbances by using the disturbance-related probability values and the series of associated features for each of the subset of service records to identify the deviations from the normal non-disturbance event distributions further comprises:
automatically applying a threshold function to sum a series of disturbance intensities associated with multiple sub-regions to obtain a standardized disturbance indicator value for a larger region.

14. The computer system of claim 8, wherein automatically identifying the subsets of the service records corresponding to the series of the newly-discovered disturbances by using the disturbance-related probability values and the series of associated features for each of the subset of service records to identify the deviations from the normal non-disturbance event distributions further comprises:
automatically applying an activation function configured to strengthen each signal of disturbance, the activation function configured to prevent disturbance signal dilution caused by a series of simultaneously detected disturbances.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
automatically receiving, by a computer, a set of service records from a data source, each service record corresponding to disturbance-revealing events within a specified region occurring during a time period, each service record further including disturbance-related probability values corresponding to the disturbance-revealing events, and wherein one or more service records are mislabeled or have no label relating to an associated disturbance;
automatically removing from the set of service records any service records having a disturbance-related probability value above a threshold that are associated with a known global storm;
automatically generating baselines for a series of relevant subregions associated with a remaining set of service records, and normalizing daily summaries of disturbance probabilities for each of the relevant sub-regions;
automatically identifying subsets of service records corresponding to a series of newly-discovered disturbances by using the disturbance-related probability values and a series of associated features for each of the subset of service records to identify deviations from normal non-disturbance event distributions;
automatically filtering out service records in the identified subset of service records corresponding to known disturbances;
automatically aggregating and splitting the known disturbances and the newly-discovered disturbances to obtain a final set of disturbances, and applying a common metric to determine a score for each of the newly-discovered disturbances; and
automatically identifying and outputting a series of influential disturbances, the series of influential disturbances comprising newly-discovered disturbances for which the determined scores are above a predetermined threshold.

16. The computer program product of claim 15, wherein automatically identifying the subsets of the service records corresponding to the series of the newly-discovered disturbances by using the disturbance-related probability values and the series of associated features for each of the subset of service records to identify the deviations from the normal non-disturbance event distributions further comprises:
automatically utilizing a calibrated cumulative sum (CUSUM) algorithm to identify disturbance signals.

17. The computer program product of claim 15, the method further comprising:
automatically determining start dates and end dates for each of the identified subsets of service records corresponding to the series of newly-discovered disturbances.

18. The computer program product of claim 15, wherein the common metric comprises a standardized value reflecting scale and impact of a set including both the known disturbances and the newly-discovered disturbances based upon one or more associated disturbance features, the one or more associated disturbance features comprising one or more of: geographic impact features, temporal impact features, or event impact features.

19. The computer program product of claim 15, the method further comprising:
automatically performing a remediation process to update the received set of service records in view of the newly-discovered disturbances.

20. The computer program product of claim 15, wherein automatically identifying the subsets of the service records corresponding to the series of the newly-discovered disturbances by using the disturbance-related probability values and the series of associated features for each of the subset of service records to identify the deviations from the normal non-disturbance event distributions further comprises:
automatically applying a threshold function to sum a series of disturbance intensities associated with multiple sub-regions to obtain a standardized disturbance indicator value for a larger region.
